(19) United States
(12) Patent Application Publication
(10) Pub. No.: US 2009/0018249 A1
(43) Pub. Date: Jan. 15, 2009

(54) Hydrophobic self-cleaning coating compositions

(76) Inventors: Subbareddy Kanagasabapathy, Lexington, KY (US); Richard J. Baumgart, Paris, KY (US); Michael Dituro, Huntington, WV (US); Wen-Chen Su, Lexington, KY (US); Frances E. Lockwood, Georgetown, KY (US)

Correspondence Address: WOOD, HERRON & EVANS, LLP, 2700 CAREW TOWER, 441 VINE STREET, CINCINNATI, OH, 45202, US

(21) Appl. No.: 11/699,883

(22) Filed: Jan. 30, 2007

Related U.S. Application Data
(60) Provisional application No. 60/763,294, filed on Jan. 30, 2006.

(51) Int. Cl. C08K 3/22; C08K 3/36

(52) U.S. Cl. 524/434; 524/493

(57) ABSTRACT

A hydrophobic self cleaning coating composition that can be applied by conventional methods such as by spraying the composition onto a surface forming creating a wet and dry dirt repellent coating on the surface. The coating utilizes hydrophobic nanoparticles of fumed silica and/or titania in a solvent which evaporates at ambient temperature. The coating solves the problem of poor resistance to UV light, opaque appearance, and/or abrasion found in previous coatings of similar nature. Virtually transparent coating are produced as compared to conventional coatings of comparable hydrophobicity which are typically white or opaque. The coating can be applied by a single and easy spraying method and the super hydrophobic property can be achieved by drying the film by evaporation of the solvent at ambient temperature for 5 to 10 minutes. Embodiments of the hydrophobic self-cleaning coating composition can be produced resulting in a clear coating or in some cases a translucent dirt repellant film or coating on painted material, plastic, metal, glass, ceramic, fiberglass or a polymer substrate. One preferred coating composition utilizing an effective amount of a treated fumed silica in a solvent forms a coated surface providing a contact angle of at least 165 degrees as compared to water having a contact angle of from 10 to 15 degrees on a noncoated surface. The self-cleaning coating composition imparts a degree of hydrophobicity to a surface so that the treated surface will have a tilt angle of sliding of less than 2 degrees as compared to water on a noncoated surface having a tilt angle of sliding of 90 degrees or higher.

### RELATED APPLICATIONS

This application claims priority from U.S. Provisional Application Ser. No. 60/763,294 filed on Jan. 30, 2006 which is incorporated by reference herein in their entirety. Reference to documents made in the specification is intended to result in such patents or literature cited being expressly incorporated herein by reference, including any patents or other literature references cited within such documents as if fully set forth in this specification.

### TECHNICAL FIELD

The technical field of this invention is producing super hydrophobic coatings on surfaces.

### BACKGROUND OF THE INVENTION

This invention relates to protection of various surfaces from contaminants and from oxidation of surfaces in air and moisture. One of the primary applications includes the use of this technology in vehicle appearance products. Although, products for similar applications are widely available on the market, these products often require rinsing with water after use and usually rely on a temporary hydrophilic surface. Typically when the water dries from the surface, water marks, smears or spots are left behind due to the deposits of minerals which were present as dissolved solids in water. This problem is apparent when cleaning glass, painted surfaces, steel, alloy, plastic or ceramic surfaces. A means of solving this problem known in the literature is to dry the water from the surface using a cloth or chamois before the water marks form. However, this drying process is time consuming and requires considerable physical efforts.

### DESCRIPTION OF THE PRIOR ART

There are several published articles which address the elimination of water marks. In one example, U.S. Pat. No. 5,759,980, a composition, comprises a surfactant package consisting of a silicone-based surfactant and a polymer which is capable of bonding to a surface to make a hydrophilic film which eliminates the problem of water marks. However, this hydrophilic coating may tend to be removed from the surface by a single water rinse. German publication DE-A21 61 591 also describes a composition for cleaning cars wherein the surface is again made hydrophilic by using amino functional polymers. This coating also tends to be rinsed off from a single rinse. In another example, PCT Wo97/48927 teaches a direct method of a cleaning composition, method of application and apparatus. This reference describes using a spray gun comprising separate chambers for the cleaning solution and ion exchange resin. Moreover, it recommends to use purified rinse water which is expensive to use. There are number of waxes and other products available in the market for attempting to retain this spot free finish. Typically these products are designed to hydroponically modify the surfaces after waxing so that the water will bead up on the hydrophobic surface. However, the hydrophobicity of the surfaces is not sufficient enough to bead the water completely from the surface thereby leaving the water spot when the water dries. Moreover, the prior art relating to hydrophobic and/or self-cleaning coatings is primarily related to permanent attachment to the substrate being coated rather than being a temporary and replenish able coating.

Therefore, there is a need to develop a process and coating for protecting various surfaces from the appearance of water marks, corrosion, and dirt repellency, while maintaining the water repellency even after several water rinses. U.S. Patent publication 20060110542 published on May 25, 2006 discloses a composition for forming a detachable and renewable protective coating produced by making a highly concentrated dispersion of hydrophobically modified silica particles in the presence of a disilazane derivative under high shear conditions.

### SUMMARY OF THE INVENTION

The present invention relates to a process and composition for creating super hydrophobic coatings (contact angle >165 degree) on various surfaces, preferably plastics, metals, glass, ceramics, wood, and painted and/or waxed surfaces. Super hydrophobic coatings of this type have recently been cited for the purpose of keeping surfaces cleaner, similar to the lotus plant, and the high contact angle is known as the “lotus effect” which depends upon having a hydrophobic surface formed of wax with an irregular surface texture caused by nanometer sized projections or irregularities whereby the surface area of a drop of liquid such as water is not great enough to overcome the high contact angle formed with the hydrophobic surface resulting in the liquid being repelled from the surface. Examples of commercially available materials which attempt to produce this “Lotus” cleaning effect are products sold under the trade name of MINCOR available from BASF, and TEGTOP available from Degussa. These products, have been tested for their ability to protect various surfaces from the appearance of water marks, corrosion, and dirt repellency and while maintaining the water repellency, but were deemed unsuitable. When coated alone or mixed with various types of hydrophobic particles, these and many other polymers, e.g. acrylic resins, silicon containing graft copolymers, functional/non functional siloxanes, inorganic hybrids such as silsesquioxanes, acrylic polymers containing perfluoro pendant groups, polytetrafluroethylene, NAFION type fluoro polymers, urethanes, fluorourethanes, polyethers, polyesters and silicon modified polyacrylates, it was found that the resulting coating is initially super hydrophobic and may remain so for long periods indoors; however, when exposed to outdoor UV light, rubbed even slightly, or in general exposed to weather, the coating loses super hydrophobicity (which we define as the instant shedding of water with no remaining drops) and becomes less hydrophobic within days or even hydrophilic and hence less useful for the object of the present invention. Examination under the microscope after a week of exposure on a panel in a UV cabinet reveals that a coating made from fumed silica and at least one film forming binder as taught in U.S. Pat. No. 6,683,126 disintegrates. None of the conventional hydrophobic compositions known provide a long lasting super hydrophobic coating that has the benefit of self cleaning of various surfaces and will reduce icing caused by water drops. Moreover, snow and ice covering horizontal surfaces can be more easily removed from the surfaces protected with the coating formed from the composition of the present invention. The coatings of the instant invention are inexpensive compared to paint and can be sprayed regularly if necessary to keep the surface clean without any further steps.

The static contact angle of a drop of liquid can be used to measure the wettability of surfaces. The static contact angle, (“contact angle”), can be defined as the angle enclosed by the surface and a tangent along the surface of the liquid drop in the region of the contact point of the liquid drop with the surface. The contact angle is measured through the liquid drop. A contact angle of 0 defines complete wettability and does not form a drop. A contact angle of 180 degrees defines complete unwettability.

The hydrophobic self-cleaning coating composition of the present invention forms an almost clear, transparent dirt repellant film or coating on painted material, plastic, metal, glass, ceramic, fiberglass or polymer substrate. A preferred coating composition comprising an effective amount of a treated fumed silica in a selected solvent applied to a surface resulted in a coated surface providing a contact angle of at least 165 degrees as compared to water having a contact angle of from 10 to 15 degrees on a noncoated surface. The composition also imparted a degree of hydrophobicity to the treated surface resulting in a tilt angle of sliding of less than 2 degrees as compared to water on a noncoated surface having a tilt angle of sliding of 90 degrees or higher.

In the instant invention, compositions are provided having a small amount of nanoparticles of fumed silica and/or titania, or other hydrophobic nanoparticles component with good UV light stability and good adhesion to metals, glass, plastic, painted and many other surfaces. The composition does not comprise any binding materials as taught in the prior art.

Although a variety of nanoparticles will work if coated with a hydrophobic material, e.g. silsesquioxanes, perfluoroacrylic resins etc. only a few polymers serve as an adequate base for the particles because the surface area of exposed polymer is vastly increased due to very thin film and rough surface area produced by the coating. This problem was either not understood or not solved in the prior art references.

It is an object of the present invention to provide a formulation of a hydrophobic coating which resists abrasion and the elements particularly ultraviolet “UV” light. UV light stability of the super hydrophobic coatings is extremely important especially for exterior surfaces such as on automobiles and other vehicles used for transportation and recreation.

It is an object of the present invention to provide a super hydrophobic coating, which is so hydrophobic that water will bounce off the surface of nominally horizontal coated plates. In this case the contact angle is so large (greater than 165 degree) that it cannot be measured by conventional instrumentation.

Another object of the present invention is to provide coatings that are practical in use, that do not degrade rapidly in sunlight, that can be readily applied, and have enough resistance to abrasion to survive for a practical length of time, preferably for weeks or months depending upon environmental conditions to which the coating is exposed.

The present invention provides a coating composition and process for generating transparent, near-transparent, and semi-transparent super-hydrophobic coatings on surfaces having a contact angle of greater than 165 degrees.

The super hydrophobic coating composition that can be used to make wet and dry dirt repellent surfaces to keep the surfaces clean for a reasonable period of time. More particularly, the particle may be silicon based including, for example, silica, silicates and polysilsesquioxane. A nanocomposite structure may be formed by casting, depositing or forming the material including nanocomposite particles.

The coating solves the problem of poor resistance to UV light and/or abrasion found in previous coatings of similar nature. The transparent, near transparent, or translucent coatings can be produced using the current invention whereas previous coatings of comparable hydrophobicity have all been white or opaque.

A preferred composition utilizes a fumed silica compound such as a hydrophobic fumed silica in an amount of up to 10 percent by weight based on the total weight of the composition. Optionally a fragrance can be added to the formulation. In addition, a propellant can be added to the formulation. Other optional components which may be added to the composition which are not required, but impart desirable qualities to the composition include a colorant such as a dye or pigment in an effective amount of about 0.005 percent by weight of the total composition; a fragrance such as bubblegum in an effective amount of about 0.10 percent by weight of the total composition; and/or a preservative such as SURCIDE P in an effective amount of about 0.1 percent by weight of the total composition.

It is an object of the present invention to apply the hydrophobic nanoparticles containing composition by conventional methods of application such as by spraying,

It is an object of the present invention to provide a hydrophobic self-cleaning coating on a selected substrate upon curing by evaporation without requiring the application of heat.

It is an object of the present invention to provide a super hydrophobic self-cleaning nanoparticles containing composition which can be sprayed in a broad range of solid mixtures using VOC complaint solvents with aerosol propellants. For instance, a pressurized liquid propellant may be utilized as a carrier to apply the foamed film coating. The preferred embodiments of the present invention use a nonfloronated propellant. A commercial liquid hydrocarbon propellant which is compatible with the preferred composition may be selected from the group of A-31, A-46, A-70, or A-108 propane/isobutane blends, with A-46 and A-70 being the most preferred propellant for use with particular compositions. The composition may contain up to 25 weight percent of the propellant, and more preferably from 5 to 20 weight percent of the propellant.

It is an object of the present invention to provide a hydrophobic self-cleaning composition which upon application to a surface forms a uniform coating by drying and evaporation of the solvent forming a coating or film at ambient temperature within 5 to 10 minutes.

Accordingly, it is an object of the present invention to provide a clear, translucent, pigmented, flourescent, dyed, tinted, or illuminative hydrophobic self-cleaning coating for application to a metal, plastic, glass, cloth, ceramic, clay, fiber, concrete, brick, rock, cinder block, paper, film, or wood surface.

It is an object of the present invention to be applicable in a pressurized container, tube, aerosol, or spray bottle.

It is an object of the present invention to provide a self-cleaning coating which can be removably placed upon a solid substrate such as paints, metals, plastics, concrete, natural and synthetic elastomers, and ceramics and removed by washing or applying pressure to the coating wiping same from the treated surface.

It is an object of the present invention to provide a water based or solvent based carrier for the self-cleaning hydrophobic coating for use on metal, plastic, glass, paper, or wood surfaces having existing protective coatings of paint, varnish, film, without damaging the existing protective coatings.

It is another object of the present invention to produce a coating which does not damage the surface.

It is yet another object of the present invention to produce a protective coating which will not damage paint, chrome, plastic, fiberglass, or other substrate to be coated therewith.

It is another object of the present invention to produce a self cleaning hydrophobic coating which is easily to apply as a liquid, foam, jell, paste, semi-solid, or aerosol.

It is another object of the self cleaning hydrophobic coating embodiment to be applied to surfaces without complicated apparatus.

It is yet another object of the self-cleaning hydrophobic coating to cure by evaporation of a selected solvent at ambient temperature and not requiring a cross-linking curing agent.

It is an object of the present invention to provide a self-cleaning hydrophobic coating which can be applied by brush, roll, spray, or dipping onto dry surfaces.

It is an object of the present invention to be used for treating non-porous and porous surfaces such as automotive and household materials including wheels, wheel trim, wheel covers, removable wheel covers, splash guards, car panels and painted surfaces, clear-coated car surfaces, metal, painted metal fixtures, chromed articles, bumpers, bumper stickers, bug deflectors, rain deflectors, vinyl materials including car boots, wheel covers, convertible tops, camper awnings, sun shades, vehicle covers, license plates, plastic articles, lens covers, signal light lens covering, brake light lens covering, headlamp and fog light lens, vinyl, rubber, plastic, and leather surfaces, dashboard, dash instrument lens covering, seats, carpet, and floor runners.

It is an object of the present invention to be used for treating kitchen and bathroom areas, living areas, interior and exterior surfaces of appliances and/or articles of furniture.

It is an object of the present invention to be used for treating metals, metal oxides, aluminum, anodized aluminum, painted substrates, stainless steel, chrome, clear-coated automotive surfaces, elastomers, vinyl, plastics, polymers, sealed wood, laminates, composites, and the like.

It is an object of the present invention to be used for treating carpet, curtains, marble, granite, stone, brick, concrete, grout, mortar, drywall, spackling, plaster, adobe, stucco, unglazed tile, tile, unglazed porcelain, porcelain, clay, wallpaper, cardboard, paper, wood, and the like.

The foregoing objects are accomplished by selecting hydrophobic nanoparticles which enables the formulation of a composition without any binder which will produce a practical self cleaning coating that is not easily destroyed by fog, UV light, abrasion, or by flowing water.

Other objects, features, and advantages of the invention will be apparent with the following detailed description taken in conjunction with the accompanying drawings showing a preferred embodiment of the invention and appended claims.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 shows the typical contact angle of coated and uncoated area of a panel.

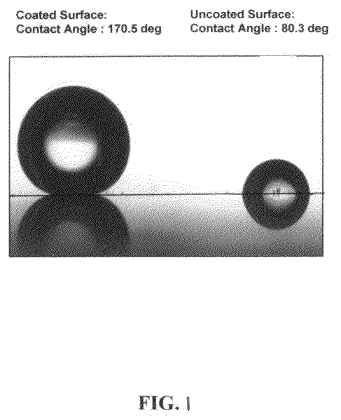

### DESCRIPTION OF THE PREFERRED EMBODIMENT

The present invention provides a coating composition which is super hydrophobic, and when applied on a surface, typically metal, fiberglass, plastic, ceramic, glass, painted material, etc. produces a difficult to wet surface. Contact angles of a liquid such as water on the coated surface should be difficult to measure with conventional means because the water droplet bounces or runs off the surface when applied. The contact angle exceeds 165 degrees and the tilt angle of sliding is less than 2 degrees.

The coatings in the examples are optimized formulations that contain super hydrophobic nanoparticles, for example, fumed silica and/or titania. Although a variety of nanoparticles will work if treated with a hydrophobic material, e.g. silsesquioxanes, perfluoroacrylic resins etc. only few polymers serve as an adequate base for the particles because the surface area of exposed polymer is vastly increased due to very thin film and rough surface area produced by the coating.

The present invention provides a formulation which can utilize nanoparticles in the composition without any binder to produce a practical lotus effect that is not easily destroyed by fog, UV light, or abrasion, or by flowing water.

This transparent, uniform film is stable when exposed outdoors to strong UV light, rain, wind, etc. for a minimum time of one month, compared to 3 days for most other polymers including acrylates, urethane acrylates, homopolymers and copolymers of ethylenically unsaturated monomers, acrylic acid/maleic anhydride copolymers etc. Stability is determined by observing that the super hydrophobic effect has not diminished and by examining the film under the microscope before and after exposure.

Nanoparticles that can be used to make the coatings of this invention are generally from the class of fumed silica's and hydrophobic titania's and zinc oxides, e.g. DEGUSSA AEROSIL R8200, DEGUSSA AEROSIL 812 S, and CAB-O-SIL TS 530, TS 610, TS 720. The particle size of the nanoparticles are from about 7 to 100 nanometers. To make the silica coating easier to apply it can be dispersed in solvents, preferably acetone and/or aliphatic hydrocarbons and/or other VOC complaint solvents to make it sprayable. The solvent may also be selected from the groups consisting of an alcohol, a hydrocarbon, mineral spirits, or water.

A preferred method of application is by spraying the solvent/particle dispersion as an aerosol. Suitable propellants are carbon dioxide, a hydrocarbon (for example mixtures of propane, butane and isobutane), a fluorocarbon, difloroethane, or compressed air. One preferred hydrocarbon is a propane/isobutane.

A more detailed description of the ingredients utilized in the preferred embodiments of the self-cleaning hydrophobic composition is as follows:

Amounts listed in percentage are in weight percent as indicated as “wt. %”, (based on 100 wt. % active) of the total composition or formulation described. As used herein, the term “particle” is intended to include any discrete particle, primary particle, aggregate and/or aggregated collection of primary particles, agglomerate and/or agglomerated collection of aggregates, and/or colloidally dispersed particles, aggregates, agglomerates and/or loose assemblies of particulate materials, and combinations thereof.

### Hydrophobic Surface Modifier

The coatings in the examples are optimized formulations that contain super hydrophobic nanoparticles. Although a variety of nanoparticles will work if coated with a hydrophobic material, e.g. fumed silica and/or titania, perfluoroacrylic resins etc. only few polymers serve as an adequate base for the particles because the surface area of exposed polymer is vastly increased due to very thin film and rough surface area produced by the coating.

It is believed the instant composition is a novel combination of synergistic components even without the addition of a hydrophobic fumed silica; however, a preferred embodiment of the present invention contains hydrophobic fumed silica in an effective amount of up to 5 percent by weight of the total composition. The more preferred embodiments of the invention utilizes an effective amount of ranging from 0.001 to 4.9 percent by weight, and more preferably in a range of from to 0.01 to 4.0 percent by weight, and more preferably in a range of from between 0.01 to 3.0 percent by weight, and more preferably between 0.1 to 2.0 percent by weight, and more preferably between 0.1 to 1.0 percent by weight based on the total weight of the composition. One preferred embodiment as set forth in Example 1, uses nanoparticles of fumed silica in an amount of about 0.5 percent by weight based on the total weight of the composition.

It is contemplated that titanium nanoparticles in a range of from 50 to 4,000 nm would also be utilized in an effective amount of ranging from 0.001 to 4.9 percent by weight, and more preferably in a range of from to 0.01 to 4.0 percent by weight, and more preferably in a range of from between 0.01 to 3.0 percent by weight, and more preferably between 0.1 to 2.0 percent by weight, and more preferably between 0.1 to 1.0 percent by weight based on the total weight of the composition.

Suitable hydrophobically modified fumed silica particles that may be used in the present invention include silica particles that have been hydrophobicized by any means known in the art.

The composition of the present invention contains a hydrophobic fumed silica such as sold under the trade name of AEROXIDE LE3 to generate self cleaning nanostructured hydrophobic surfaces which repel water. The average particle size distribution of particles is believed to be between 100 to 4,000 nanometers. The LE 3 brand has a specific surface area (BET) of 100 ±30 m²g, a carbon content of 3 to 6 weight percent, tapped density of approximately 60 g/l (According to (DIN EN ISO 787/11, August 1983), and a moisture of less than or equal to 1.0 weight percent (2 hours at 105 C).

Several types of hydrophobically modified fumed silica is set forth in U.S. Patent Publication No. US 2006/0110542 by Dietz et al. Published on May 25, 2006 which is incorporated by reference herein and are described as follows:

Colloidal silicon dioxide is a generally fumed silica prepared by a suitable process to reduce the particle size and modify the surface properties. The surface properties are modified to produce fumed silica by production of the silica material under conditions of a vapor-phase hydrolysis at an elevated temperature with a surface modifying silicon compound, such as silicon dimethyl bichloride. Such products are commercially available from a number of sources, including Cabot Corporation, Tuscola, Ill. (under the trade name CAB-O-SIL) and Degussa, Inc., Piscataway, N.J. (under the trade name AEROSIL).

Suitable hydrophobically modified fumed silica particles include, but are not limited to:

those commercially available from Degussa Corporation, Parsippany, N.J., as designated under the R Series of the AEROSIL[R] and AEROXIDE[R]LE trade names. The different AEROSIL[R]R and AEROXIDE[R]LE types differ in the kind of hydrophobic coating, the BET surface area, the average primary particle size and the carbon content. The hydrophobic properties are a result of a suitable hydrophobizing treatment, e.g., treatment with at least one compound from the group of the organosilanes, alkylsilanes, the fluorinated silanes, and/or the disilazanes. Commercially available examples include AEROSIL[R]R 202, AEROSIL[R]R 805, AEROSIL[R] R 812, AEROSIL[R]R 812 S, AEROSIL[R] R 972, AEROSIL[R]R 974,

AEROSIL[R]R 8200, AEROXIDE[R]LE-1 and AEROXIDE[R] LE-2.

Other silica materials are also suitable when hydrophobically modified by use of hydrophobizing materials capable of rendering the surfaces of the silica particles suitably hydrophobic. The suitable hydrophobizing materials include all those common in the art that are compatible for use with the silica materials to render their surfaces suitably hydrophobic. Suitable examples, include, but are not limited to: the organosilanes, alkylsilanes, the fluorinated silanes, and/or the disilazanes. Suitable organosilanes include, but are not limited to: alkylchlorosilanes; alkoxysilanes, e.g., methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, butyltrimethoxysilane, butyltriethoxysilane, hexyltrimethoxysilane, octyltrimethoxysilane, 3-mercaptopropyltrimethoxysilane, n-octyltriethoxysilane, phenyltriethoxysilane, polytriethoxysilane; trialkoxyarylsilanes; isooctyltrimethoxy-silane; N-(3-triethoxysilylpropyl) methoxyethoxyethoxy ethyl carbamate; N-(3-triethoxysilylpropyl) methoxyethoxyethoxyethyl carbamate; polydialkylsiloxanes including, e.g., polydimethylsiloxane; arylsilanes including, e.g., substituted and unsubstituted arylsilanes; alkylsilanes including, e.g., substituted and unsubstituted alkyl silanes including, e. g., methoxy and hydroxy substituted alkyl silanes; and combinations thereof. Some suitable alkylchlorosilanes include, for example, methyltrichlorosilane, dimethyldichlorosilane, trimethylchlorosilane, octylmethyldichlorosilane, octyltrichlorosilane, octadecylmethyldichlorosilane and octadecyltrichlorosilane. Other suitable materials include, for example, methylmethoxysilanes such as methyltrimethoxysilane, dimethyldimethoxysilane and trimethylmethoxysilane; methylethoxysilanes such as methyltriethoxysilane, dimethyldiethoxysilane and trimethylethoxysilane; methylacetoxysilanes such as methyltriacetoxysilane, dimethyldiacetoxysilane and trimethylacetoxysilane; vinylsilanes such as vinyltrichlorosilane, vinylmethyldichlorosilane, vinyldimethylchlorosilane, vinyltrimethoxysilane, vinylmethyldimethoxysilane, vinyldimethylmethoxysilane, vinyltriethoxysilane, vinylmethyldiethoxysilane and vinyldimethylethoxysilane.

Suitable disilazanes include for example, but are not limited to: hexamethyldisilazane, divinyltetramethyldisilazane and bis(3,3-trifluoropropyl)tetramethyldisilazane. Cyclosilazanes are also suitable, and include, for example, octamethylcyclotetrasilazane. It is noted that the aforementioned disilazanes and cyclosilazanes typically have the basic formula (I) and (II) described above. Thus, these disilazanes and cyclosilazanes can be used as either or both as hydrophobizing material for hydrophobically modifying fumed silica particles and as a processing aid in forming the pre-dispersion mentioned supra.

Suitable fluorinated silanes include the fluorinated alkyl-, alkoxy-, aryl- and/or alkylaryl-silanes, and fully perfluorinated alkyl-, alkoxy-, aryl- and/or alkylaryl-si lanes. Examples of fluoroalkyl silanes include, but are not limited to: those marketed by Degussa under the trade name of Dynasylan. An example of a suitable fluorinated alkoxy-silane is perfluorooctyl trimethoxysilane.

### Hydrocarbon Solvents

To make the hydrophobic silica or titanium coating easier to apply it can be dispersed in solvents, preferably alcohol, acetone and or aliphatic hydrocarbons and/or other VOC complaint solvents to make it sprayable.

Organic solvents useful in the present invention include isoparaffins, aliphatic hydrogen solvents, paraffinic solvents, paraffins, synthetic isoparaffinic solvents. They aid in the control and dispersion of the hydrophobic nanoparticles. They reduce the tendency of the solids to gum and minimize swirl marks.

### Light Hydrocarbon Distillate

The solvent concentration consisting of light distillate hydrocarbons and isoparaffinic hydrocarbons can vary from about 15% to about 85% by weight of the final formulation.

In addition to being a carrier for the film forming ingredients, the hydrocarbon solvent functions both to remove oil based stains as well as to dissolve polish previously deposited on the surface preventing polish buildup. The hydrocarbon solvent should have an appropriate evaporation rate in order to provide adequate contact time to dissolve old polish on the surface to be treated, but not so slow as to result in smearing and loss of gloss of the deposited film. Moreover, the hydrocarbon solvent aids in cleansing and in the aid of the removal of residual water upon application of the product on a surface.

Light Distillate solvents useful in the formulation are predominately aliphatic hydrocarbon solvents and other light distillates. For instance, hydrocarbons containing up to 100 percent aliphatic hydrocarbons are most preferable and hydrocarbons containing less than 1 percent aromatic content are deemed very desirable. Also useful are solvents typically containing from about 10 to 90 percent aliphatic hydrocarbons and from about 0 to 10 percent aromatic hydrocarbons. Solvents deemed suitable which contain less than 10% aromatic hydrocarbons include odorless mineral spirits, Stoddard solvent, and mixed alkanes that have a flash point of about 40° C. A light distillate sold under the trade name of CALUMET 420-460 (LVP100), which is utilized at about 31.3 percent by weight of the total composition.

Light Distillate hydrocarbons containing up to 100 percent aliphatic hydrocarbons are most preferable and hydrocarbons containing less than 1 percent aromatic content are deemed very desirable. Also useful are solvents typically containing from about 10 to 90 percent aliphatic hydrocarbons and from about 0 to 10 percent aromatic hydrocarbons. Solvents deemed suitable which contain less than 10% aromatic hydrocarbons include odorless naphtha mineral spirits, turpentine, kerosene, V.M.& P, naphtha, Stoddard solvent, and mixed alkanes that have a flash point of about 40° C.

### Isoparaffinic Hydrocarbon High Boiling Organic Solvent

A synthetic isoparaffinic hydrocarbons such as ISOPAR G, ISOPAR M, ISOPAR E, CONOSOL 200, LPA 210, LVP 200 are also useful isoparaffinic hydrocarbon solvents in the present invention.

In addition to the aliphatic hydrocarbon distillate, a preferred embodiment utilizes an isoparaffinic organic solvent added to the composition to aid in cleansing and aid in the removal of residual water upon application of the product on a surface.

Preferred organic solvents are sold under the trade name of ISOPAR which are synthetically produced isoparaffinic solvent sold by ExxonMobil Chemical Company which exhibit a low surface tension and also aid in the spreadability of soluble components. The isoparaffinic solvents are highly aliphatic compounds containing a high percentage of isoparaffins. The organic solvents used in the present invention are typically considered high boiling solvents having a low vapor pressure typically less than 1.0 mm Hg at 20° C. and preferably 0.1 mm Hg or less at 20° C. Furthermore, the most preferred ISOPAR solvents reportedly have a vapor pressure of about 10 mm Hg at 38° C. and more preferably have a vapor pressure of about 4 mm Hg at 38° C. The evaporation rate is an important criteria in selection of the organic solvent.

For instance, a preferred ISOPAR solvent is ISOPAR G which has a distillation range for IBP of 163 and DP of f176, a flash point of 41° C. and evaporation rate of 21 at (N-BuAc=100). A preferred embodiment utilizes ISOPAR G

It is also anticipated that white spirits, such as are produced by SHELLSOL (Shell Co. And EXXSOL produced by ExxonMobil Corporation can also be utilized as the solvent.

As set forth in U.S. Publication 20060110642, suitable solvents can be selected from the group of aromatic, branched, cyclic, and/or linear hydrocarbons with 2 to 14 carbon atoms, optionally substituted with fluorine or chlorine atoms, monovalent linear or branched alcohols, aldehydes or ketones with 1 to 6 carbon atoms, ethers or esters with 2 to 8 carbon atoms, linear or cyclic polydimethylsiloxanes with 2 to 10 dimethylsiloxy units, or mixtures thereof. Examples of these solvents include, but are not limited to: n-propane, n-butane, n-pentane, cyclo-pentane, n-hexane, cyclo-hexane, n-heptane, isododecane, kerosene, methanol, ethanol, 1-propanol, isopropanol, 1-butanol, dimethylether, diethylether, petroleum ether and ethylacetate, octamethyltrisiloxane, marketed under the trade name Dow Corning 200 Fluid 1 cst, decamethylcyclopentasiloxane, marketed under the trade name Dow Corning 245 (available from Dow Chemical), TEGO[R] Polish Additiv 5 (available from Degussa), perfluorinated solvents, and other halogenated materials such as chlorinated solvents are also suitably employed where their use is appropriate.

Other solvents which may be utilized with the present invention include organic solvents having some water solubility and/or water miscibility, and at least some ability to couple with water or moisture that may be present or become incorporated into the inventive treatment compositions through processing, packaging and during application. These are generally added in addition to the more volatile solvent, although they may be employed alone as well as in any suitable combination or mixture capable of stabilizing the dispersion of the hydrophobically modified silica particles during processing, packaging, storage and use such as: C1-6 alkanols, C1-6 diols, C1-10 alkyl ethers of alkylene glycols, C3-24 alkylene glycol ethers, polyalkylene glycols, short chain carboxylic acids, short chain esters, isoparafinic hydrocarbons, mineral spirits, alkylaromatics, terpenes, terpene derivatives, terpenoids, terpenoid derivatives, formaldehyde, and pyrrolidones. Alkanols include, but are not limited to: methanol, ethanol,-n-propanol, isopropanol, butanol, pentanol, and hexanol, and isomers thereof. Diols include, but are not limited to: methylene, ethylene, propylene and butylene glycols. Alkylene glycol ethers include, but are not limited to: ethylene glycol monopropyl ether, ethylene glycol monobutyl ether, ethylene glycol monohexyl ether, diethylene glycol monopropyl ether, diethylene glycol monobutyl ether, diethylene glycol monohexyl ether, propylene glycol methyl ether, propylene glycol ethyl ether, propylene glycol n-propyl ether, propylene glycol monobutyl ether, propylene glycol t-butyl ether, di- or tri-polypropylene glycol methyl or ethyl or propyl or butyl ether, acetate and propionate esters of glycol ethers. Short chain carboxylic acids include, but are not limited to: acetic acid, glycolic acid, lactic acid and propionic acid. Short chain esters include, but are not limited to: glycol acetate, and cyclic or linear volatile methylsiloxanes.

Organic solvents that are less volatile can optionally be included in combination with the more volatile solvent for the purpose of modifying evaporation rates. Suitable examples of less volatile organic solvents are those with lower vapor pressures, for example those having a vapor pressure less than 0.1 mm Hg (20 [deg]C.) which include, but are not limited to: dipropylene glycol n-propyl ether, dipropylene glycol t-butyl ether, dipropylene glycol n-butyl ether, tripropylene glycol methyl ether, tripropylene glycol n-butyl ether, diethylene glycol propyl ether, diethylene glycol butyl ether, dipropylene glycol methyl ether acetate, diethylene glycol ethyl ether acetate, and diethylene glycol butyl ether acetate (all available from ARCO Chemical Company).

The solvent is present at a level of less than 50 percent by weight based on the total weight of the composition, and preferably in an effective amount of between 0.001 to 50 percent by weight, more preferably between 0.001 to 49 percent by weight, more preferably from 0.001 to 30 percent by weight, more preferably in an effective amount of between 0.01 to 20 percent by weight, more preferably between 0.01 to 10 percent by weight, more preferably from 0.01 to 5 percent by weight, more preferably between 0.01 to 2 percent by weight, more preferably from 0.01 to 1 percent by weight, more preferably in an effective amount of between 0.1 to 0.9 percent by weight, more preferably between 0.1 to 0.8 percent by weight based on the weight of the total composition. One preferred embodiment contains an effective amount of about 0.5 percent by weight of the total composition.

### UV Protection (Zinc Oxide)

A conventional zinc oxide can be used in the instant formulation to provide UV protection to the instant composition; however, a preferred embodiment of the present invention utilizes a micro fine transparent nanometer sized zinc oxide powder which offers exceptional and along lasting broad spectrum UV-B/UV-A protection. It is highly effective to protect transparent plastics and plastic films from harmful ultraviolet radiation. Its homogeneous small particles and narrow particle size distribution provides for excellent transparency. It is non-migratory and has antibacterial properties.

Regular commercially available zinc oxides have specific surface areas below 10 m₂/gr, (typically 4-6 m₂/gr), resulting in high primary particle sizes which results in white particle in appearance. The mean particle diameter of the zinc oxide is about 35 nanometers and the majority of the particles range from about 20 to 35 nanometers. One source of the nanometer sized zinc oxide, (ZANO 20) is Umicore Zinc Chemicals in Belguim. The preferred embodiment utilizes zinc oxide particles having a specific surface area of minimum 20 m₂/gr, resulting in very fine loosely aggregated particles having a primary particle size below 60 nanometer providing a narrow particle size distribution allowing the zinc oxide to be used in transparent applications. Additional zinc oxide products available from Umicore Zinc Chemicals suitable for use in the present invention is sold under the tradename of ZANO LS and has a specific surface are of 20-30 m₂/gr and a primary particle size (calculated) of about 35-55 nanometers; and ZANO HS which has a specific surface are of 30-40 m₂/gr and a primary particle size (calculated) of about 25-35 nanometers. The homogeneous particle size distribution of the nanometer sized particle and its fine primary particle size result in good transparency. The nanometer sized zinc oxide particles are broad spectrum UV absorbers (UV-A and UV-B) which is not the case for micro fine TiO2 and organic UV absorbers. It also has anti-bacterial properties and is mildew resistant.

An alternate embodiment utilizes zinc oxide having an average particle size of 60 nanometers (calculated via SSA measurement) sold under the tradename of NANOGARD by Nanophase Technologies Corporation, in Romeoville, Ill. Although it is sold as a white powder, the nanometer sized particles in low concentrations utilized in the preferred embodiments of the instant invention appear transparent.

The zinc oxide in at least one preferred embodiment of the present invention is present in an effective amount of up to 1.0 percent by weight of the total composition. The more preferred embodiments of the invention utilizes an effective amount of glycerin ranging from 0.001 to 1.0 percent by weight, and more preferably in a range of from to 0.005 to 0.6 percent by weight, and more preferably in a range of from between 0.01 to 0.4 percent by weight, and more preferably between 0.05 to 0.2 percent by weight based on the total weight of the composition.

One preferred embodiment uses nanoparticles of zinc oxide in an amount of about 0.1 percent by weight based on the total weight of the composition.

### Silicon Fluids

One or more silicon fluids such as liquid dimethyl polysiloxanes is used in the present invention to aid in spreading and leveling of the components upon application. The dimethyl polysiloxane is typically obtained commercially as a silicone oil which is added to the blend of other constituents and mixed together to form the final composition. Dimethyl polysiloxane from Dow Corning is sold under the trademark 200 FLUID or from General Electric sold under the trademark SF96 polydimethylsiloxane fluid. As reported in General Electric's formulary guide at www.gesilicones/com/silicones/americas/business/industries/formulary-guide.shtm on is February of 2002, these fluids are often characterized as amine functional fluids, however, they are actually curable polymers containing reactive alkoxy groups which upon hydrolyzation convert to silanol (OH) units. The silanol further react to form a cross-linked siloxane linkage (Si—O—Si) on the polish surface. These amine groups increase the bonding properties to the polish surface either through ionic attraction or chemical reaction. The ionic and/or chemical bond insures resistance to detergent wash-off or micro abrasion during use of the polished surface.

One preferred embodiment of the present invention utilizes a blend containing DOW CORNING Silicon Fluid which are medium viscosity polydimethylsiloxane in an amount of up to 10 percent by weight of fluid having a viscosity range of from 100 to 1,000 cst. More preferably, the embodiment contains a silicone fluid blend with 100 cst silicon fluid in an amount of from about 0.001 to 4.0 percent by weight of the total weight of the composition and/or a 350 cst silicon fluid in an amount of from about 0.01 to 3.0 percent by weight of the total weight of the composition and/or a 1,000 cst silicon fluid in an amount of from about 0.1 to 2.0 percent by weight of the total weight of the composition.

A preferred substituted polysiloxane materials used in this invention include those with organic groups having from one to seven carbon atoms such that the substituted polysiloxanes have lower alkyls that provide an average of 0.3 to 1.5, preferably 0.5 to 1.3, carbon atoms per silicon atom. Aqueous dispersions of lower alkyl substituted polysiloxanes of this invention can be prepared by hydrolysis of the corresponding alkyl substituted silanes by conventional methods.

### Optional Additives

Dyes, fungicides, and/or colorants may also be added to the composition in an effective amounts of less than 1 percent by weight/each based on the total weight of the composition.

### Fragrances

Although not required, an effective amount of one or more fragrances, such as vanilla, bubble gum, orange, fruity bouquet and the like may be added to the instant invention to impart a desirable scent to the product. Preferably the fragrance is present in an amount of up to 1 percent by weight, and more preferably of from between 0.001 to 1.0 percent by weight, and more preferably of from between 0.01 to 0.5 percent by weight.

### Dyes

As an option, a dye can be added to the composition to provide a desirable color or tint. A preferred dye for the composition set forth in Example 1 is LIQUITINT royal blue L95010 in an amount of about 0.005 percent based on the total weight of the composition. Of course, it is contemplated that an effective amount could comprise more or less dye or tint up to 1% of the total weight of the composition.

Other colorants suitable for use in the instant composition include metallized azos such as barium or calcium salts, naphthol, pyrazalones, rhodamines, quinacridones, phthalocyanines, phthalocyanines, pigments including the magnesium salts, lead chromes and silicochromates, zinc chromes, barium chromate, strontium chromate, titanium nickel yellow, liminites, haematites, magnetites, micaceous oxides of iron, iron ferreites and Prussian blue.

### Preservatives:

A biocide, such as DANTOGARD (DMDM Hydantoin) or TROYSAN 395 can be optionally used as a preservative in the product. The biocide is not a necessary component to provide a functional composition for use on surfaces; however, the preservative provides a useful shelf life to the product. The biocide preservative is added in an effective amount to preserve the composition product and ranges from 0.01 to 1.0 percent by weight, and more preferably in a range of from 0.05 to 1.0 percent by weight, and more preferably in a range of from between 0.1 and 0.5 percent by weight based on the total weight of the composition. Other preservatives such as polymethoxybicyclic oxazolidine may also be useful in the present invention. It is recommended as an option to add a biocide such as DANTOGARD in an amount up to 1 percent or more preferably in an amount of about 0.12 percent by weight of the total composition. Another biocide which can be added as an option is SURCIDE P in an amount up to 1 percent or more preferably in an amount of about 0.4 percent by weight of the total composition.

### Propellant:

A preferred method of application is by diluting the solvent an aerosol containing a propellant such as carbon dioxide, a hydrocarbon (for example mixtures of propane isobutane), a fluorocarbon, difloroethane, and compressed air. One preferred hydrocarbon is a propane/isobutane.

A pressurized liquid propellant is utilized as a carrier to apply the composition. A commercial liquid hydrocarbon propellant can be selected which is compatible with the preferred composition may be selected from the pressured propane/isobutane/butane blends, with the most preferred propellant as 46 psi or 70 psi for use with particular compositions. A commercial liquid hydrocarbon propellant is selected from the group consisting of A-31, A-46, A-55, A-70, or A-108, and/or propane/isobutane/butane blends, with A-46 and A-70 being the most preferred propellant for use with particular compositions. The composition may contain up to 30 weight percent of the propellant, and more preferably from 5 to 20 weight percent of the propellant. Moreover the composition can be formulated as a premix liquid concentrate and mixed with a desired amount of propellant. For example, a typical formula may contain about 88 percent by weight of a premix liquid concentrate and about 12 percent by weight of a selected propellant. As an alternative, a nonfloronated hydrocarbon propellant such as pressurized air, N2, CO₂ may also be used.

The composition may contain up to 30 weight percent of propellant, and more preferably from 5 to 20 weight percent of propellant. About 10-12 percent by weight is usually considered to be sufficient.

### Preparation:

The hydrophobic fumed silica is blended into the solvent until completely dispersed and then the zinc oxide is mixed until a good dispersion is obtained at ambient temperature. The mixture is then placed in an aerosol container with an effective amount of a propellant to spray the composition onto the surface to be treated. If used, a fragrance, colorant, or preservative is added prior to adding the composition to its container.

### Application and Method of Use:

A preferred method of treatment of a surface with the composition of the present invention is generally applied as an aerosol in a manner so as to deposit fine droplets of the composition comprising the colloidally dispersed hydrophobically modified fumed silica particles in a solvent as a continuous coating upon a receptive surface such that the droplets completely cover the surface to effectively merge to form a thin continuous transparent film coating. The film dries by evaporation of the solvent within a few minutes leaving a deposited film of particles in the form of silica particle agglomerates than is essentially transparent. The uniform and transparent film is detachable and renewable. It exhibits dirt-repellency and water repellency owing to high water contact angles sufficient to effect beading water incident on the surface so that the deposited film exhibits provides soil and water repellency. Moreover, the treated surface is self-cleaning.

Application of the coating by spraying the solvent/particle dispersion as an aerosol utilizes a suitable propellant such as carbon dioxide, a hydrocarbon (for example mixtures of propane, butane and isobutane), a fluorocarbon, difloroethane, or compressed air. One preferred hydrocarbon is a propane/isobutane. To make the silica coating easier to apply it can be dispersed in solvents, preferably acetone and/or aliphatic hydrocarbons and/or other VOC complaint solvents to make it sprayable. The solvent may also be selected from the groups consisting of an alcohol, a hydrocarbon, mineral spirits, or water. The hydrocarbon solvent aids in cleansing and in the aid of the removal of residual water upon application of the product on a surface.

The composition is applied as a substantially clear hydrophobic self-cleaning coating to a metal, plastic, glass, cloth, ceramic, clay, fiber, concrete, brick, rock, cinder block, paper, film, or wood surface. After application of a uniform coating to the treated surface, the composition cures by drying and evaporation of the solvent forming a coating or film at ambient temperature within 5 to 10 minutes of the application.

### EXAMPLES

The following examples further describe the polishing compositions of the instant invention, methods of using the polishing compositions, and the tests performed to determine the various characteristics of the polishing compositions. The examples are provided for exemplary purposes to facilitate understanding of the invention and should not be construed to limit the invention to the examples.

This transparent, uniform film is stable when exposed outdoors to strong UV light, rain, wind, etc. for a minimum time of one month, compared to 3 days for most other polymers including acrylates, urethane acrylates, homopolymers and copolymers of ethylenically unsaturated monomers, acrylic acid/maleic anhydride copolymers etc. Stability is determined by observing that the super hydrophobic effect has not diminished and by examining the film under the microscope before and after exposure.

The following examples provide formulations of compositions in accordance with the present invention and provide examples of the range of ingredient percentages by weight providing an effective amount of the particular ingredients deemed necessary to obtain the desired results in single application.

One preferred formulation for the composition of the present invention is set forth in Example 1 as follows:

### Example 1

A typical formulation consists of 0.5 wt % solid of treated fumed silica (AEROSIL R 812 from Degussa) in acetone. The final formulation is coated on a painted metal panel using an aerosol propellant. The film generated by this formulation showed excellent super hydrophobic property (contact angle >165 degree). The super hydrophobic property was retained for more than 4 weeks, when the film was exposed to UV light, rain etc.

### Example 2

Another preferred embodiment is for a formulation similar to Example 1 except that the Example 2 composition contains 0.1 wt % of polymer (polymer NA from Wacker Chemie) as a binder was coated on a painted metal surface. The film generated by this formulation showed excellent super hydrophobic property (contact angle >165 degree). The super hydrophobic property was maintained for more than 4 weeks under UV light, rain etc.

### Example 3

Another preferred embodiment comprises a formulation similar to example 1 except that the example 3 contains 0.05% of ZnO as a UV stabilizing material was coated on a painted metal surface. The film generated by this formulation showed excellent hydrophobic property (contact angle >165 degree). The super hydrophobic property was maintained for more than 4 weeks.

### Example 4

Another preferred embodiment comprises a formulation similar to example 1 except that the example 4 contains 0.3 wt % of binder polymer, (aminofunctional siloxanes from Dow Corning) as a binder was coated on a painted metal surface. The film generated by this formulation didn't show super hydrophobic property.

It is believed the nano sized particles are bound to the treated surface by hydrophobic-hydrophobic interactions and van der Waals forces sufficient to enable the hydrophobically modified silica particles to bind tightly to the substrate surface to effectively resisting displacement even when subjected to moderate air or water pressure such as associated with the operation of vehicles.

The coating is removed by abrasion, rubbing or wiping using a wiping article. Other means such as detergents with surface active agents, dispersants or cleaning solvents can also be used to remove the coating from the treated surface. Rain water or splashed water is not effective in removal of the coating of the present invention providing a removable protective coatings that repels dirts and grime and effectively provides a coating preventing adhesion of dust and contaminants such as brake dust from sticking firmly to the treated surface facilitating removal of same with less effort.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented herein above. Rather, what is intended to be covered is within the spirit and scope of the appended claims.

We claim:

1. A hydrophobic self-cleaning coating composition, comprising:
a hydrophobic fumed silica ranging in size from 1000 to 4,000 nanometers in an effective amount of up to 5.0 percent by weight based on the total weight of the composition;
a solvent or solvent mixture selected from straight or branched, linear or cyclic aliphatic, 10 or aromatic hydrocarbons with 2 to 14 carbon atoms, monovalent linear or branched alcohols with 1 to 6 carbon atoms, ketones or aldehydes with 1 to 6 carbon atoms, ethers or esters with 2 to 8 carbon atoms, or linear or cyclic polydimethylsiloxanes with 2 to 10 dimethylsiloxy units, in an effective amount of up to 50 percent by weight based on the total weight of the composition;
said coating composition resulting in a coated surface providing a contact angle of at least 165 degrees as compared to water having a contact angle of from 10 to 15 degrees on a noncoated surface and said coating composition imparting a degree of hydrophobicity to said coated surface so that said coated surface has a tilt angle of sliding of less than 2 degrees as compared to water on said noncoated surface having a tilt angle of sliding of 90 degrees or higher.

2. The composition of claim 1, wherein said effective amount of said treated fumed silica is about 0.5 wt % solid of the silica/solvent composition.

3. The composition of claim 1, wherein said composition is clear upon application to a treated surface.

4. The composition of claim 1, wherein said composition is translucent upon application to a treated surface.

5. The composition of claim 1, including an aerosol.

6. The composition of claim 1, wherein said composition is dispersed in an aerosol propellant containing a solvent selected from the group consisting of an alcohol, a hydrocarbon, mineral spirits, or water.

7. The composition of claim 1, wherein said aerosol propellant is selected from the group consisting of a carbon dioxide, a hydrocarbon, a fluorocarbon, or compressed air.

8. The composition of claim 7, wherein said hydrocarbon, comprises propane/isobutane.

9. The composition of claim 1, including a treated binding agent applied to said substrate, producing a hydrophobic self-cleaning coating composition.

10. The composition of claim 9, wherein said treated binding agent comprises a pretreatment solution containing a zinc oxide.

11. The composition of claim 10, wherein said treated binding agent comprises about 0.05% by weight of said pretreatment solution.

12. The composition of claim 11, wherein said pretreatment agent is zinc oxide.

13. The composition of claim 1, wherein said composition is applied to a waxed surface.

14. The composition of claim 1 wherein said nanoparticles of a treated fumed silica have a particle size ranging from about 7 to about 100 nanometers.
